(19) United States
(12) Patent Application Publication
(10) Pub. No.: US 2019/0212435 A1
(43) Pub. Date: Jul. 11, 2019

(54) Method and Assembly for Monitoring a Hot Gas Region of a Gas Turbine

(71) Applicant: Siemens Aktiengesellschaft, Muenchen (DE)

(72) Inventors: Uwe Pfeifer, Berlin (DE); Andreas Ziroff, München (DE)

(73) Assignee: Siemens Aktiengesellschaft, Muenchen (DE)

(21) Appl. No.: 16/328,812

(22) PCT Filed: Jul. 20, 2017
(86) PCT No.: PCT/EP2017/068393

§ 371 Date: Feb. 27, 2019

(30) Foreign Application Priority Data
Aug. 31, 2016 (DE) 10 2016 216 412.0

(51) Int. Cl. G01S 13/90; G01S 7/03; F01D 21/00; F01D 5/00; F01D 5/28

(52) U.S. Cl. CPC G01S 13/90; G01S 7/032; F01D 21/003; F05D 2270/805; F01D 5/284; F05D 2260/83; F01D 5/005

(57) ABSTRACT

Various embodiments may include a method for monitoring a hot gas region of a gas turbine comprising: monitoring the region using an imaging radar assembly remote from the region, connected to the region with a hollow conductor. The hollow conductor is closed off at a first end proximate the radar assembly. The radar assembly operates outside the closed-off cavity and the second end opens into the region or is shielded against heat but permeable to radar waves passing into the region. The radar is actuated in time intervals wherein at least parts of the hot gas space are detected by the radar assembly repeatedly at the time intervals. The method includes: feeding acquired image data to an evaluation device; evaluating the acquired image data against a predefined maintenance requirement; and triggering a maintenance alarm as a function of the result of the evaluation.

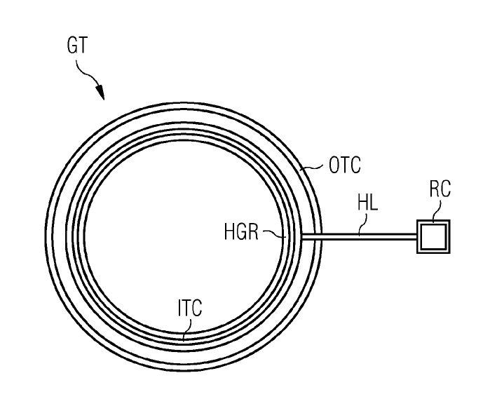

### CROSS-REFERENCE TO RELATED APPLICATIONS

This application is a U.S. National Stage Application of International Application No. PCT/EP2017/068393 filed Jul. 20, 2017, which designates the United States of America, and claims priority to DE Application No. 10 2016 216 412.0 filed Aug. 31, 2016, the contents of which are hereby incorporated by reference in their entirety.

### TECHNICAL FIELD

The present disclosure relates to gas turbines. Various embodiments may include methods for monitoring a hot gas region of a gas turbine and/or assemblies for monitoring a hot gas region of a gas turbine.

### BACKGROUND

Modern gas turbines typically include ceramic-coated rotor blades and guide blades in the turbine. This ceramic layer is known as “temperature barrier coating” (TBC) and may be applied by means of various technologies to the metallic basic structure of the blades and has layer thicknesses in the range of a few tenths of a millimeter. As a result of long-term application of extremely high temperatures to the blades or due to over-firing or other burner malfunctions it may be found, however, that the ceramic heat protection layer is damaged and becomes partially detached or flakes off.

As a result, the metallic basic structure of the turbine blades is exposed, resulting in further severe, rapidly progressing damage. In an extreme case, this can lead to total damage to the turbine, which in turn causes damage of the order of millions of euros. It is therefore of great interest to monitor the state of the ceramic protective layer. Hitherto it has been known that detailed inspection of the state of the ceramic coating over an entire area can be carried out only by deactivation and manual inspection.

This is complicated and expensive, however, and so-called “real-time” infrared cameras have been developed which supply image information both of the ceramic protective layer of the rotating rotor blades and of a limited field of vision of a number of guide blades, said information being formed from the depiction of contrasts in the visible/invisible infrared range. However, this solution has proven to have the disadvantage of high costs owing to the camera system itself and owing to the provision of the necessary visual access.

### SUMMARY

The teachings of the present disclosure describe a monitoring technology which overcomes the disadvantages of the prior art. For example, some embodiments include a method for monitoring a hot gas region of a gas turbine, characterized in that: a) the hot gas region is connected to an imaging radar assembly which is operated at a location on the gas turbine remote from the hot gas region, by means of at least one hollow conductor, b) the hollow conductor is closed off at the end at which the radar assembly is operated, in such a way that the radar assembly is operated outside the closed-off cavity, and is configured at the end of the hollow conductor facing the hot gas region in such a way that the hollow conductor opens into the hot gas region or is shielded against heat in a way which is permeable to radar waves in such a way that the radar waves pass into the hot region, c) the radar assembly is actuated and functionally connected to the hot gas space via the hollow conductor in such a way that at time intervals at least parts of the hot gas space are detected in an imaging fashion by the radar assembly repeatedly at time intervals, d) the acquired image data are fed to an evaluation device, and e) maintenance is initiated, in particular by triggering an alarm, as a function of the result of the evaluation device.

In some embodiments, at least one part of the blade of the gas turbine is detected in an imaging fashion as parts of the hot gas space by the radar assembly.

In some embodiments, the absolute value of the time intervals between the repetition of the imaging detection can be set synchronously with the rotational speed of the blades, in particular in a value range of 1 μs-2 μs, with the result that a rotating blade which is to be detected appears static for the imaging.

In some embodiments, the radar assembly is configured and operated such that the part of the blade is detected optically as, in particular, 16, separate partial regions.

In some embodiments, the radar assembly is operated in such a way that beam-forming methods, generated by, for example, a digital beam-forming method, also referred to as “digital beam forming”, and/or by phase-controlled group antennas, referred to as “phased array”, are carried out.

In some embodiments, the radar assembly is operated as what is referred to as a “synthetic aperture radar” device.

As another example, some embodiments includes an assembly for monitoring a hot gas region of a gas turbine, characterized in that: a) an imaging radar assembly which is operated at a location on the gas turbine which is remote from the hot gas region is connected to the hot gas region by means of at least one hollow conductor, b) a hollow conductor which is closed off at the end at which the radar assembly is arranged, in such a way that the radar assembly is positioned outside the closed-off cavity and is configured at the end of the hollow conductor facing the hot gas region, in such a way that the hollow conductor opens into the hot gas region or is shielded against heat in a way which is permeable to radar waves, in such a way that the radar waves pass into the hot region, c) the radar assembly is actuated and functionally connected to the hot gas space via the hollow conductor in such a way that at time intervals at least parts of the hot gas space are detected in an imaging fashion by the radar assembly repeatedly at time intervals, d) an evaluation device is arranged and functionally connected to the radar assembly in such a way that the acquired image data are fed to it, and e) the evaluation device is configured in such a way that maintenance is initiated, in particular by triggering an alarm.

In some embodiments, the radar assembly, the hollow conductor and/or the ends of the hollow conductor are configured and functionally connected to one another in such a way that at least one part of the blade of the gas turbine is detected in an imaging fashion as parts of the hot gas space by the radar assembly.

In some embodiments, the radar assembly is configured in such a way that the absolute value of the time intervals between the repetition of the imaging detection can be set synchronously with the rotational speed of the blades, in particular in a value range of 1 μs-2 μs, with the result that a rotating blade which is to be detected appears static for the imaging.

In some embodiments, the radar assembly is configured and functionally connected to the hollow conductor and/or hot gas space in such a way that the part of the blade is detected optically as, in particular, 16, separate partial regions.

In some embodiments, the radar assembly is configured in such a way that beam-forming methods, generated by, for example, a digital beam-forming method, also referred to as “digital beam forming”, and/or by phase-controlled group antennas, referred to as a “phased array”, are carried out.

In some embodiments, the radar assembly is configured as what is referred to as a “synthetic aperture radar” device.

In some embodiments, the connection of the radar assembly and hot gas space is configured in such a way that it is formed by a multiplicity of hollow conductors which are arranged in the manner of a bundle.

### BRIEF DESCRIPTION OF THE DRAWING

Further advantages and details of the teachings herein are explained on the basis of an exemplary embodiment illustrated in the FIGURE.

The single FIGURE shows a schematic illustration of a possible exemplary embodiment of the assembly incorporating teachings of the present disclosure. The FIGURE is a schematic view of a possible assembly of the components in the turbine region of a heavy gas turbine GT.

### DETAILED DESCRIPTION

Some embodiments of the teachings herein may include a method for monitoring a hot gas region of a gas turbine, wherein:
a) the hot gas region is connected to an imaging radar assembly which is operated at a location on the gas turbine remote from the hot gas region, by means of at least one hollow conductor,
b) the hollow conductor is closed off at the end at which the radar assembly is operated, in such a way that the radar assembly is operated outside the closed-off cavity, and is configured at the end of the hollow conductor facing the hot gas region in such a way that the hollow conductor opens into the hot gas region or is shielded against heat in a way which is permeable to radar waves in such a way that the radar waves pass into the hot region,
c) the radar assembly is actuated and functionally connected to the hot gas space via the hollow conductor in such a way that at time intervals at least parts of the hot gas space are detected in an imaging fashion by the radar assembly repeatedly at time intervals,
d) the acquired image data are fed to an evaluation device,
e) maintenance is initiated, in particular by triggering an alarm, as a function of the result of the evaluation device.

In some embodiments, at least one part of the blade of the gas turbine may be detected in an imaging fashion as parts of the hot gas space by the radar assembly. If the absolute value of the time intervals between the repetition of the imaging detection can be set synchronously with the rotational speed of the blades, in particular in a value range of 1 μs-2 μs, with the result that a rotating blade which is to be detected appears static for the imaging, there is a development in which the very rapidly rotating rotor appears static on the radar “photograph”, and flaking off can therefore be detected well. In some embodiments, in order to ensure good spatial resolution the radar assembly is configured and operated such that the part of the blade is detected optically as, in particular, 16, separate partial regions.

In some embodiments, the radar assembly is operated in such a way that beam-forming methods, generated by, for example, a digital beam-forming method, also referred to as “digital beam forming”, and/or by phase-controlled group antennas, referred to as “phased array”, are carried out. This contributes to improving the recordings and therefore leads to more accurate results during the evaluation. In this context, the radar assembly may be operated as what is referred to as a “synthetic aperture radar” device.

Some embodiments may include an assembly for monitoring a hot gas region of a gas turbine, including:
a) an imaging radar assembly which is operated at a location on the gas turbine which is remote from the hot gas region is connected to the hot gas region by means of at least one hollow conductor,
b) a hollow conductor which is closed off at the end at which the radar assembly is arranged, in such a way that the radar assembly is positioned outside the closed-off cavity and is configured at the end of the hollow conductor facing the hot gas region, in such a way that the hollow conductor opens into the hot gas region or is shielded against heat in a way which is permeable to radar waves, in such a way that the radar waves pass into the hot region,
c) the radar assembly is actuated and functionally connected to the hot gas space via the hollow conductor in such a way that at time intervals at least parts of the hot gas space are detected in an imaging fashion by the radar assembly repeatedly at time intervals,
d) an evaluation device is arranged and functionally connected to the radar assembly in such a way that the acquired image data are fed to it, and
e) the evaluation device is configured in such a way that maintenance is initiated, in particular by triggering an alarm.

In some embodiments, the radar assembly, the hollow conductor, and/or the ends of the hollow conductor are configured and functionally connected to one another in such a way that at least one part of the blade of the gas turbine is detected in an imaging fashion as parts of the hot gas space by the radar assembly. In some embodiments, the radar assembly is configured in such a way that the absolute value of the time intervals between the repetition of the imaging detection can be set synchronously with the rotational speed of the blades, in particular in a value range of 1 μs-2 μs, with the result that a rotating blade which is to be detected appears static for the imaging.

If the radar assembly is configured and functionally connected to the hollow conductor and/or hot gas space in such a way that the part of the blade is detected optically as, in particular, 16, separate partial regions, the implementation of the method described herein may be supported. The radar assembly may be configured in such a way that beam-forming methods, generated by, for example, a digital beam-forming method, also referred to as “digital beam forming”, and/or by phase-controlled group antennas, referred to as a “phased array”, are carried out. The radar assembly may be configured as what is referred to as a “synthetic aperture radar” device.

In some embodiments, the connection of the radar assembly and hot gas space is configured in such a way that it is formed by a multiplicity of hollow conductors which are arranged in the manner of a bundle. Such examples provide redundancy which allows for the failure of individual hollow conductors as a result of any kind of contamination from the interior. Visual access to a hot gas space is therefore possible, allowing the stringent requirements which apply in a hot gas space, such as temperatures in a temperature range of up to 1700° C. and even a pressure of ˜20 bar, to be met. This can also allow for the far-reaching design compromises of the turbine components and for the otherwise extremely high structural expenditure which are necessary as a result of the considerable flow turbulence which is present there. In some embodiments, on a hollow conductor which is closed off at one side, the optical path does not necessarily have to be continuously cooled with air, of which is additionally required that it has to be very clean, which would mean a high degree of expenditure on filtering the air. In order to make available considerable quantities of the cooling air, at a high pressure level, very extensive technical installations would also be necessary, which themselves require a high level of expenditure on monitoring and control. The mixed-in cooling air may also disadvantageously influence the efficiency of the machine.

The application of the systems herein does not require any active cooling for the system if there is implementation of the invention.

As a result, on the one hand, considerable cost advantages may be achieved and, on the other hand, the negative effect of the thermodynamic circulation process as a result of the ingress of cold air is completely avoided. The efficiency level of the installation which uses it is therefore also increased. This is supported if, inter alia, in the application of imaging radar technology, there is digital beam forming or a phased array or SAR or by using conventional beam-forming methods or Rotman lenses or the like for determining the state of the ceramic coating during the ongoing operation of the gas turbine.

A turbine rotor region HGR, which is also referred to as a hot gas space according to the invention and accommodates the turbine blades (not illustrated) which are to be monitored can be seen. This hot gas space HGR is surrounded by an internal casing (“inner turbine case”) ITC—in this exemplary embodiment the cavity therefore does not open into the hot gas space but rather is configured in such a way that it is shielded against heat in a way which is permeable to radar waves, and that the radar waves pass into the hot region—and an outer casing (“outer turbine case”).

In addition, a radar assembly RC is arranged outside the gas turbine GT, wherein the distance from the gas turbine GT which is selected in the illustration is not intended to constitute an indication of the value of the distance from the radar assembly RC. The radar system RC is configured in such a way that both sufficient spatial resolution and sufficient contrast resolution are achieved. In this context, in the turbines which are currently known a sufficient spatial resolution value is considered to be one which can divide the blade which is to be modelled into at least 16 different regions and for this supplies a contrast resolution which permits an unambiguous detection of partial or complete flaking off in this region. Relatively large or relatively small division which deviates from this is possible according to the turbines used.

In some embodiments, the radar assembly RC is combined with an image processing system and an evaluation system, wherein the electronic evaluation system is configured in such a way that the chronological resolution, that is to say the imaging detection (photograph) of the blades passing by at high speed is made possible. For this purpose, in contemporary turbines an “exposure time” in the range of 1-2 μs is necessary in order to “freeze” the blades. The connected image processing system is configured and functionally connected to the evaluation system here in such a way that in the case of flaking off of the “temperature barrier coating” (TBC) of the ceramic of the ceramic-coated rotor blades and guide blades an alarm is triggered.

Inter alia the following advantages may be achieved with systems incorporating the teachings of the present disclosure:

1. The application of this technology will not require any active cooling for the system if there is implementation. As a result, on the one hand, very considerable cost advantages may be achieved and, on the other hand, the negative effect of the thermodynamic circulation process as a result of the ingress of cold air may be completely avoided.

2. It is estimated that the cost of an entire system will only be approximately 10-25% of that of an infrared camera system.

3. The application of this technology may not require any active cooling for the system. As a result, on the one hand, very considerable cost advantages may be achieved and, on the other hand, the negative effect of the thermodynamic circulation process as a result of the ingress of cold air may be completely avoided. This is achieved by applying the radar technology, which does not require visual access to the hot gas region HGR.

4. As a result of the application of the technology, considerable advantages may be obtained in the long-term operation of the gas turbine GT. The possibility of an immediate warning in the event of a fault prevents consequential damage to the turbine in the range of millions. The continuous status information may provide a long-term and continuous image of the aging process of each individual blade. This may permit reliable and cost-optimized planning of the maintenance process and planning of the provision of the very expensive turbine blades. Very high cost saving potentials may be implemented for any power plant installation in the range of millions.

What is claimed is:

1. A method for monitoring a hot gas region of a gas turbine, the method comprising:
monitoring the hot gas region using an imaging radar assembly operated at a location on the gas turbine remote from the hot gas region, connected to the hot gas region by means of at least one hollow conductor;
wherein the hollow conductor is closed off at a first end proximate the radar assembly, wherein the radar assembly operates outside the closed-off cavity, wherein a second end of the hollow conductor proximate the hot gas region opens into the hot gas region or is shielded against heat in a way permeable to radar waves wherein the radar waves pass into the hot gas region;
wherein the radar assembly is actuated and functionally connected to the hot gas space via the hollow conductor in time intervals wherein at least parts of the hot gas space are detected by the radar assembly repeatedly at the time intervals;
feeding acquired image data to an evaluation device;
evaluating the acquired image data against a predefined maintenance requirement; and
triggering a maintenance alarm as a function of the result of the evaluation.

2. The method as claimed in claim 1, further comprising detecting at least one part of a blade of the gas turbine as parts of the hot gas space.

3. The method as claimed in claim 2, wherein an absolute value of the time intervals between the repetition of the imaging detection is synchronous with a rotational speed of the blades so a rotating blade appears static for the imaging.

4. The method as claimed in claim 1, wherein the part of the blade is detected optically as 16 separate partial regions.

5. The method as claimed in claim 1, further comprising imaging using digital beam-forming methods and/or by phase-controlled group antennas.

6. The method as claimed in claim 1, wherein the radar assembly comprises a synthetic aperture radar.

7. An assembly for monitoring a hot gas region of a gas turbine, the assembly comprising:
a hollow conductor connected to the hot gas region and feeding a location on the gas turbine remote from the hot gas region;
an imaging radar assembly operated at the location remote from the hot gas region;
wherein the hollow conductor is closed off at a first end at the remote location;
the radar assembly is disposed outside a cavity defined by the closed off first end;
the hollow conductor opens into the hot gas region or is shielded against heat in a way which is permeable to radar waves and the radar waves pass into the hot region;
the radar assembly is actuated so, at specified time intervals parts of the hot gas space are detected by the radar assembly repeatedly;
an evaluation device fed images by the radar assembly; and
an alarm triggered by the evaluation device to initiate maintenance if the evaluation of the images meets a predefined standard.

8. The assembly according to claim 1, wherein the radar assembly and the hollow conductor are configured so at least one part of a blade of the gas turbine is detected as parts of the hot gas space by the radar assembly.

9. The assembly as claimed in claim 8, wherein the radar assembly is configured so an absolute value of the time intervals between the repetition of the imaging detection is synchronous with a rotational speed of the blades, so a rotating blade appears static for the imaging.

10. The assembly as claimed in claim 8, wherein the radar assembly is configured so the part of the blade is detected optically as 16 separate partial regions.

11. The assembly as claimed in claim 8, wherein the radar assembly includes digital beam forming and/or a phased array.

12. The assembly as claimed in claim 8, wherein the radar assembly comprises a synthetic aperture radar device.

13. The assembly as claimed in claim 8, wherein the connection of the radar assembly and hot gas space is formed by a multiplicity of hollow conductors arranged in a bundle.
